(19) United States
(12) Patent Application Publication
(10) Pub. No.: US 2011/0201353 A1
(43) Pub. Date: Aug. 18, 2011

(54) SELF-OPTIMIZING DETERMINATION OF ROUTING AREAS IN LAND MOBILE NETWORKS

(76) Inventor: Gerrit Voehringer, Bonn (DE)

(21) Appl. No.: 13/063,762

(22) PCT Filed: Aug. 13, 2009
(86) PCT No.: PCT/EP2009/005926

§ 371 Date: Mar. 18, 2011

(30) Foreign Application Priority Data
Sep. 19, 2008 (DE) 10 2008 048 103.3

(51) Int. Cl. H04W 24/00

(52) U.S. Cl. 455/456.1

(57) ABSTRACT

Process for operating a cellular land mobile network which is formed by a plurality of cells, several cells being combined at one time into a routing area, by means of which the cell terminals checked into the land mobile network can be located and addressed in this routing area, the cell terminals checked into the routing area being detected and to set up a connection to a cell terminal, paging of all cells of this routing area to the cell terminal taking place, when leaving the routing area a location up-date being executed, the routing areas being dynamically formed depending on the network parameters and/or parameters of use.

The invention relates to a process for operating a cellular land mobile network which is formed by a plurality of cells, several cells being combined at one time into a routing area by means of which the cell terminals checked into the land mobile network can be located and addressed in this routing area, the cell terminals checked into the routing area being detected, and to set up a connection to a cell terminal, paging of all cells of this routing area to the cell terminal taking place, when leaving the routing area the location being updated.

In current land mobile networks and GSM networks, groups of cells are combined in a so-called routing area, within which the mobile terminal moves without a change of the cell in current use having to be reported by location update to the network. This process takes place for reasons of energy saving and to minimize the amount of signaling within the routing area.

In the case of a paging, in all cells within the routing area, paging for the mobile terminal is executed which is then reported from the currently used cell within the routing area. This process is used to set up a cell connection to the cell terminal.

For the size of the routing area a compromise is made between the number of required location updates on the one hand and the number of cells in which paging can take place on the other, since it would fundamentally be a good idea to keep down both the number of necessary location updates when leaving the routing area and on the other hand the number of cells in which paging must take place.

In this establishment of routing areas it is disadvantageous that when a cell is set up again within the cellular land mobile network the affected routing area must be matched to this cell and the surrounding cells. Furthermore it is disadvantageous in this type of establishment of routing areas that for example for major events or traffic jams a very large signaling load and optionally even an overload in individual cells and routing areas can occur, while possibly a directly bordering routing area may be completed unburdened.

The object of the invention is to overcome these disadvantages and to devise a process for operating a cellular land mobile network of the initially mentioned type which enables optimization with respect to the signaling load, the number of required location updates and the number of cells in which paging must take place.

This object is achieved as claimed in the invention by a process as claimed in claim 1. Advantageous developments of the invention are given in the dependent claims.

In the process for operating a cellular land mobile network, especially a LTE network which is formed by a plurality of cells, several cells at a time being combined into a routing area, by means of which the cell terminals checked into the land mobile network can be located and addressed in this routing area, the cell terminals checked-in in the routing area being acquired and paging of all cells of this routing area to the cell terminal taking place to set up a connection to a cell terminal, when leaving the routing area a location update being carried out, it is especially advantageous that the routing areas are dynamically formed depending on the network parameters and/or parameters of use.

Among network parameters and/or parameters of use, especially the following parameters can be acquired and considered: the size of the routing area, the number of cells which form the routing area, the re-establishment of one or more cells, i.e. the change and/or expansion of the network infrastructure, the number of cell terminals currently checked-in in the individual cells, or also the number of current cell connections, i.e. the load in the land mobile network, etc.

With the introduction of Long Term Evolution (LTE) the is fixed establishment of a routing area is cancelled and replaced by a so-called “tracking area” which is likewise labeled a routing area. This tracking area is characterized in that it can be established individually for each cell terminal, i.e. that the network in a location update transmits to the cell terminal an optionally specific list of cells within which the cell terminal can travel without reporting its position. The use of the invention in so-called LTE networks is especially advantageous.

By means of the process as claimed in the invention it is thus possible that the network itself can determine how an optimized tracking area can be determined and fixed especially per cell terminal, i.e. a corresponding routing area. In this way planning and expansion of the network infrastructure are also facilitated.

In particular, it is possible with the invention to easily incorporate the cell into the routing area when the cell is re-established without the routing area having to the matched to the cell and the surrounding cells. This matching which has been necessary to date according to the prior art becomes superfluous by the process as claimed in the invention.

Furthermore, it is possible by the process as claimed in the invention to automatically orient routing areas, i.e. especially tracking areas, to the actual demand and thus also to automatically take into account changes and other influences, for example by major events, road blockages, traffic jams or the like and to consider them by the dynamic formation of routing areas depending on the network parameters and/or parameters of use.

For dynamic determination of optimized tracking areas the actual movement of the cell terminals can be used. Preferably the routing areas are formed depending on the probability of spillover of a checked-in cell terminal from one cell into the next, i.e. that especially those cells are combined into a routing area in which there is an increased probability that these cells will be used in succession by a cell terminal.

Preferably by means of statistical evaluations is the probability of spillover of a checked-in cell terminal from a first cell into a next cell determined and the routing area is dynamically formed by the cell in which a cell terminal is presently checked in being combined into a routing area with those cells for which the probability that the cell terminal directly or indirectly spills over into this cell or cells exceeds a definable boundary value.

Due to the mechanism of the tracking area a cell terminal in the “idle mode”, i.e. in readiness operation, reports its current cell only when leaving the tracking area. There are different possibilities for collecting the travel data, of which two are described below:

The first version is a stochastic approach. For each n-the location update, for example for n=1000, the tracking area is limited to the current cell. As soon as this cell terminal leaves the cell, a location update is carried out again, from which the new cell can be determined. This location update necessarily takes place since by limiting the tracking area to the current cell, leaving the cell corresponds a change of the tracking area.

Because this process only rarely applies depending on n, the effect on the battery service life and to the signaling load is low. After initialization of a new cell, n can be chosen to be small in order to more quickly collect a larger amount of significant data.

Furthermore n can also be automatically adapted depending on the available data, i.e. that for little available data n is chosen to be smaller, conversely for a large number of available data n can be chosen to be large.

From this stochastic approach it can thus be determined in which cells proceeding from a certain cell a spillover predominantly takes place. From these statistical data then the spillover probability from one cell into a certain adjacent cell can be determined.

Another possibility for determining these data is a cell change during a call. During a call the cell currently in use at the time in the MSC is known. The MSC is the mobile switching center in the land mobile network. Furthermore, in the MSC all passages from cell to cell are known so that a movement profile can also be determined from these data, i.e. that it can be determined from these data by means of a corresponding evaluation from which cells to which cells spillovers predominantly occur. Thus the probability of a spillover from one cell into a certain adjacent cell can also be determined from these data.

Preferably formation of the routing areas takes place depending on the current use and/or loading of individual or is several cells of the land mobile network.

In this way it is especially possible to consider the effects of major events, road blockages, traffic jams, etc. If for example there are several dozen thousand individuals on a fairground or in a stadium, the area being covered by several cells, it is a good ideas to combine these cells not in a single routing area, but into several bordering routing areas so that the signaling load in each individual tracking area can be kept relatively small.

Preferably a routing area is dynamically formed for each individual cell terminal or for groups of cell terminals. In this way further optimization of the signaling load and size of the routing areas is possible by combining cells into one such routing area. Preferably the routing areas are formed by geographically coherent cells so that one coherent area at a time can be covered.

Preferably the dynamic formation of a routing area is initiated by the execution or initiation of the location update. When leaving a tracking area, a location update is automatically triggered. This location update can be used to dynamically form the new tracking area. In this connection especially the cell of the old tracking area used last and the cell of the new tracking area used first are considered, i.e. that especially the direction of travel can be considered and evaluated.

In the formation of the routing area the cell(s) used last and/or before by the cell terminal are especially preferably considered. In particular, the direction of travel of the cell terminal can be determined there from and considered. In this way is further optimization of the routing areas is possible. Thus, from the collected data the probability for cell change depending on the currently used cell and the cell used before or the cells used before can also be determined in order to thus take into account the direction of travel. For example, on a highway the tracking area is usefully computed and fixed in the direction of travel, conversely cells in the other direction of travel should not be a component of the tracking area. In this way further optimization of the signaling load is possible since those cells into which the cell terminal cannot usefully travel need not be considered in paging to set up a cell phone call. In this way unnecessary signaling can be avoided within the land mobile network.

In the simplest case the process as claimed in the invention for each cell uses the probabilities of passage into other cells which are computed from the collected location update data.

If now a ME (cell terminal) initiates a location update, for the current cell it is determined which other cells will be used in the future with a defined probability; here the process is recursive (by all possible paths to other cells being computed with corresponding probabilities) so that other remote cells can be taken onto the list with the corresponding probability.

This list is now assigned to the ME as the tracking area. Example: Let there be cells A-E with the following passage possibilities:

### EXAMPLE

Let there be cells A-E with the following passage possibilities:

| | to cell A | to cell B | to cell C | to cell D | to cell E |
|---|---|---|---|---|---|
| from cell A | | 50% | 50% | 0 | 0 |
| from cell B | 40% | | 35% | 25% | 0 |
| from cell C | 50% | 40% | | 10% | 0 |
| from cell D | 0 | 25% | 15% | | 60% |
| from cell E | 0 | 0 | 0 | 80% | |

A location update in cell A triggers the following computation:

Cell B: 50% (A—>B)+(50%*40%) (A->C->B)=70%

Cell C: 50% {A->C)+(50%*35%) (A->B->C)=67.5%

Cell D: 0% (A->D}+(50%*25%) (A->B->D)+(50%*10%) (A->C->0+(50%*35%*10%) (A->13->C->D)=19.25%

Cell E: Cell 13*60%=11.55%

Depending on the parameterization for example only cells are considered which are used with more than 15% probability; thus only cells B, C and D are taken into the tracking area.

1. A process for operating a cellular land mobile network formed by a plurality of cells, several cells being combined at one time into a routing area serving for locating and addressing in this routing area the cell terminals checked into the land mobile network, the cell terminals checked-in in the routing area being detected and, to set up a connection to a cell terminal, all cells of this routing area are paging the cell terminal, when leaving the routing area a location update being executed, the routing areas being dynamically formed depending on the network parameters or parameters of use, the routing areas being formed depending on the probability of spillover of a checked-in cell terminal from one cell into the next cell, by means of statistical evaluations the probability of spillover of a checked-in cell terminal from a first cell into a next cell being determined and the routing areas being dynamically formed by the cell in which a cell terminal is currently checked in being combined into a routing area with those cells for which the probability that the cell terminal directly or indirectly spills over into this cell or cells exceeds a definable boundary value.

2-3. (canceled)

4. The process as claimed claim 1, wherein the routing areas are formed depending on the current use or load on individual or several cells of the land mobile network.

5. The process as claimed in claim 1, wherein one routing area is dynamically formed for each individual cell terminal or for groups of cell terminals.

6. The process as claimed in claim 1, wherein the routing areas are formed by geographically coherent cells.

7. The process as claimed in claim 1, wherein dynamic formation of a routing area is triggered by the execution of a location update.

8. The process as claimed in claim 1, wherein in the formation of the tracking area the cells used last or before by the cell terminal are considered, especially wherein the direction of travel of the cell terminals is determined and considered.

9. A method of operating a cellular land mobile network having a plurality of adjacent routing areas each covering a respective group of cells that cell terminals can check into and in which the checked-in cell terminals can be located and addressed, the method comprising the steps of:
detecting the cell terminals in the routing areas;
updating location data for a cell terminal when it leaves one of the routing areas; and
dynamically forming the routing areas depending on the probability of spillover of a check-in cell from one cell to an adjacent cell by assigning to each routing area those cells in which the probability of the respective terminals spilling over directly or indirectly exceeds a definable boundary value.
